(19) United States
(12) Patent Application Publication
(10) Pub. No.: US 2007/0192301 A1
(43) Pub. Date: Aug. 16, 2007

(54) SYSTEMS AND METHODS FOR INDEXING AND SEARCHING DATA RECORDS BASED ON DISTANCE METRICS

(75) Inventor: David Posner, Napa, CA (US)

Correspondence Address: BAKER & MCKENZIE LLP;PATENT DEPARTMENT, 2001 ROSS AVENUE, SUITE 2300, DALLAS, TX, 75201, US

(73) Assignee: ENCIRQ CORPORATION, Burlingame, CA (US)

(21) Appl. No.: 11/675,435

(22) Filed: Feb. 15, 2007

Related U.S. Application Data
(60) Provisional application No. 60/773,754, filed on Feb. 15, 2006.

(51) Int. Cl. G06F 17/30

(52) U.S. Cl. 707/3

(57) ABSTRACT

A computer implemented method for searching a data structure is disclosed. A first node on the data structure is examined. A determination is made as to whether the first node is associated with one or more child nodes. When the first node not associated with one or more child nodes, elements within the first node that are located within a defined distance away from a defined location rendered on the first node are identified. The identified elements are stored in a data set. The nodal radius cut-off value is updated if the value is less than a difference of one half a radius of the first node and a distance from the defined location to the center point of the first node. The first node is labeled to indicate that the node has been examined.

### APPLICATIONS FOR CLAIM OF PRIORITY

This application claims the benefit under 35 U.S.C. §119(e) of U.S. Provisional Application No. 60/773,754 filed Feb. 15, 2006. The disclosure of the above-identified application is incorporated herein by reference as if set forth in full.

### BACKGROUND

I. Field of the Invention

The embodiments described herein are directed to indexing and searching electronic data records, and more particularly to efficiently indexing and searching data records based on proximities to other data points as defined by distance criteria.

II. Background of the Invention

A “B-tree” data structure solves the problem of efficiently answering ordering queries, in linear space, for large data sets. Searching data sets that are too large to fit into a computer's main memory all at once requires accessing some data stored on secondary storage, such as magnetic disks. Accessing secondary storage typically takes much more time than accessing main memory. Accordingly, data structures for large data sets are designed to minimize the number of input/output (“I/O”) operations required.

B-trees are balanced trees, such that all leaf nodes are at the same depth in the tree and the height of the tree grows logarithmically with the number of nodes it contains. B-trees use large branching factors, typically constrained by how many keys can fit into one disk page, which reduces the height of the tree and therefore the number of I/O operations required to find any key. This optimizes the average number of I/O operations performed during a given search, which makes B-trees efficient for large data sets. B-trees also have the characteristic that they only need a constant number of pages in main memory at any time, thus the size of main memory does not limit that size of B-trees that can be handled.

While B-trees are useful in answering ordering queries such as “Find the element with key value K,” they are not useful in answering proximity queries such as “Find elements near point P,” where “near” is defined by reference to a distance function. For example, the user of a global positioning system (GPS) enabled device (e.g., cell phone, GPS positioning device, laptop, etc.) seeking to locate all Italian restaurants that are within a 5 mile radius of his geographic location by placing a query via a wireless network connection to an Internet server that hosts a database containing data of all restaurants within the geographic location.

There are two problems with using ordinary B-trees for these problems. First, B-trees are designed for linear spaces and whereas it is desirable to be able to answer proximity queries for spaces with 2 dimensions or more. In the present case we are interested in the two dimensional space of geographic distance. A simple approach to dealing with multiple dimensions is to use an ordinary B-tree scheme except that each level of the tree cycles through the dimensions one at a time: e.g., Level 0 splits along latitude, Level 1 splits along longitude, then latitude again, then longitude, and so on. This is spatially equivalent to partitioning the 2-d space into rectangles.

The second problem is topological, namely that nearness in space does not guarantee nearness in a search tree. This is an inherent problem even in 1-D space. The problem is points that are in fact near to each other, geographically speaking, but that straddle the tree's interval partitions. In a search tree, “nearness” is approximated by how far the search paths for two points agree (i.e., how many nodes the paths to the two points have in common). Unfortunately you can have two points arbitrarily close together in space which happen to split into different sub-trees at the first node, which is nearly impossible to detect in a B-tree without an exhaustive traversal.

An R-tree data structure can be used to address some of the shortcomings of the B-tree data structure. Mainly R-trees can be used for spatial access methods of indexing multi-dimensional information such as geographical data (i.e., X and Y coordinate data). The R-tree data structure splits space into hierarchically nested minimum bounding rectangles (i.e., nodes). However, one of the characteristics of the R-tree data structure is that the bounding rectangles only minimally overlap (i.e., non-overlapping), therefore individual data records (i.e., geographical data) are typically only stored within a single bounding rectangle, not across multiple overlapping rectangles. This may allow certain types of data records to be missed during a data query.

For example, a topological problem arises during the queries of decimal (non-integer) expansions defined within data tree structures that contain nodes that do not overlap. A decimal expansion is a search tree that splits into 10 sub-nodes at each node (1 for each possible value of the next significant digit). For example, the decimal numbers 1.00000000000 and 0.9999999999 are in fact close to each other but their expansion paths are completely divergent and therefore not detectable using nearness in data tree structures that contain nodes that do not overlap. Mathematically, the topologies correspond to “Cantor space” versus “Baire space,” where Baire space is the space of continued fractions which is topologically equivalent to the real numbers.

The topological nearness problem is increased in multi-dimensional spaces. A multi-dimensional space (in particular 2-d space) cannot be mapped to a one dimensional space such that closeness relationships are maintained (i.e., such that closeness in the one dimensional map reflects closeness in the two-dimensional space). Because closeness is a function of topology, solving the one-dimensional problem with a tree does not automatically solve the two-dimensional problem.

### SUMMARY

Systems and methods for indexing and searching data records based on distance metrics are disclosed.

In one aspect, a computer implemented method for searching a data structure is disclosed. A first node on the data structure is examined. A determination is made as to whether the first node is associated with one or more child nodes. When the first node not associated with one or more child nodes, elements within the first node that are located within a defined distance away from a defined location rendered on the first node are identified. The identified elements are stored in a data set. The nodal radius cut-off value is updated if the value is less than a difference of one half a radius of the first node and a distance from the defined location to the center point of the first node. The first node is labeled to indicate that the node has been examined.

In another aspect, a computer implemented method for inserting database records into a data structure is disclosed. A determination is made as to whether a first node is associated with one or more child nodes. When the first node is associated with one or more child nodes, elements are inserted into the first node, wherein each element represents a geographic location. A determination is made as to whether the number of elements in the first node exceeds a set number, wherein if the number of elements in the first node exceeds the set number, the first node is replaced with a set of nodes with radii that measures one half a radius of the first node and the elements are redistributed between each node of the set of nodes.

In a different aspect, a data tree structure for storing a dataset to be indexed and searched based on distance criteria is disclosed. The data tree structure includes a root node and a first sub-node. The root node is defined by a root node center point and a root node radius. The root node is configured to store elements that comprise the dataset. The first sub-node is associated with the root node. The first sub-node is defined by a first sub-node center point and a first sub-node radius. The first sub-node center point lies within one half the root node radius away from the root node center point and is configured to store a portion of the elements that comprise the data set.

These and other features, aspects, and embodiments of the invention are described below in the section entitled “Detailed Description.”

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1A is a graphical representation of a Level 0 root node of a two-dimensional P-tree data structure used to store data points of interest within a geographic region, in accordance with one embodiment.

FIG. 1B is a graphical representation of a Level 1 set of sub-nodes in a two-dimensional P-tree data structure used to store data points of interest within a geographic region, in accordance with one embodiment.

FIG. 1C is a graphical representation of a complete two-dimensional P-tree data structure used to store data points of interest within a geographic region, in accordance with one embodiment.

FIG. 2 is an illustration of a flowchart detailing a method for searching a two-dimensional P-tree data structure, in accordance with one embodiment.

FIG. 3 is an illustration of a flowchart detailing a method for inserting database records in a two-dimensional P-tree data structure, in accordance with one embodiment.

### DETAILED DESCRIPTION

Systems and methods for indexing and searching data records based on distance metrics are disclosed. It will be obvious, however, that the present invention may be practiced without some or all of these specific details. In other instances, well known process operations have not been described in detail in order not to unnecessarily obscure the present invention.

As used herein, a database is a collection of records or information which is stored in a conventional computing device in a systematic (i.e. structured) way so that a user can consult it to answer queries. Examples of the types of data structures that are used by databases to store information include: arrays, lists, trees, graphs, etc.

A tree is a widely-used data structure that emulates a tree structure with a set of linked nodes and configured to enable the manipulation of hierarchical data sets. Examples of tree-based data structures include but is not limited to: A-trees, B-trees, P-trees, R-trees, AA-trees, AVL-trees, etc. A proximity tree (“P-tree”) is a type of tree-based data structure used for maintaining and indexing a dynamic set of data from some bounded region in a Euclidean space or surface. P-trees are like B-trees except that instead of answering order queries they are intended to answer proximity queries. The data structure format of P-trees is uniquely suited for efficient execution of queries based on proximity (i.e. find all points in data set S which lie within a given distance of some specified point from the space or surface).

An important characteristic of P-tree data structures, that overcomes the topological limitations of B-tree and R-tree data structures, is that they cover a set of data points with overlapping “spheres” (e.g., intervals for 1-D space, circles for 2-D space, actual spheres for 3-D space, etc.) rather than partitioning the data space into disjointed intervals. Each such sphere is defined by a center point and a radius that is greater than zero. Each node of the P-tree corresponds to a sphere and the sub-trees of the node corresponds to overlapping sub-spheres. As such, each data point is stored within multiple nodes on the P-tree. This redundancy ensures the likelihood that a data point will be discovered regardless of which path a search algorithm takes while searching the P-tree data structure.

A network database storage device is any conventional network computing device (e.g., server, mainframe, etc.) that is used to store one or more databases. Network database storage devices can be of any make (e.g., Sun Microsystems Inc., IBM, Dell, Compaq, Hewlett Packard, etc.) running on any database protocol (e.g., Oracle, Sybase, etc.) so long as the device can be operatively connected to a network. A database network system is any client/server network that contains one or more linked network database storage devices (i.e., database servers) configured to be accessed as a data resource by one or more client devices (e.g., mobile phone, laptop, GPS positioning device, etc.).

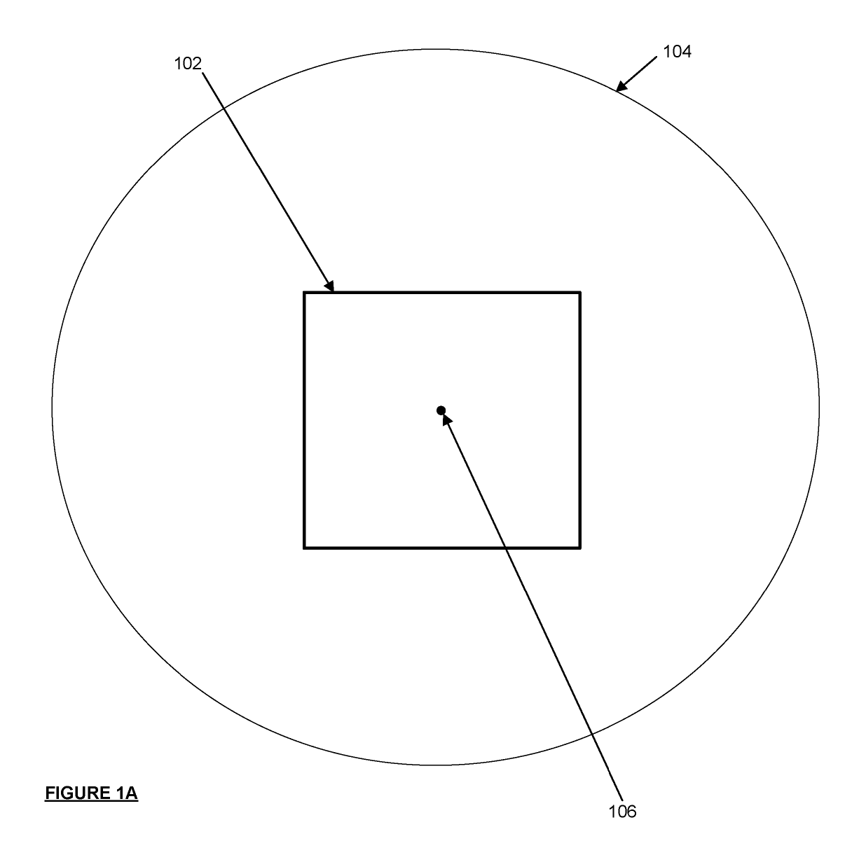

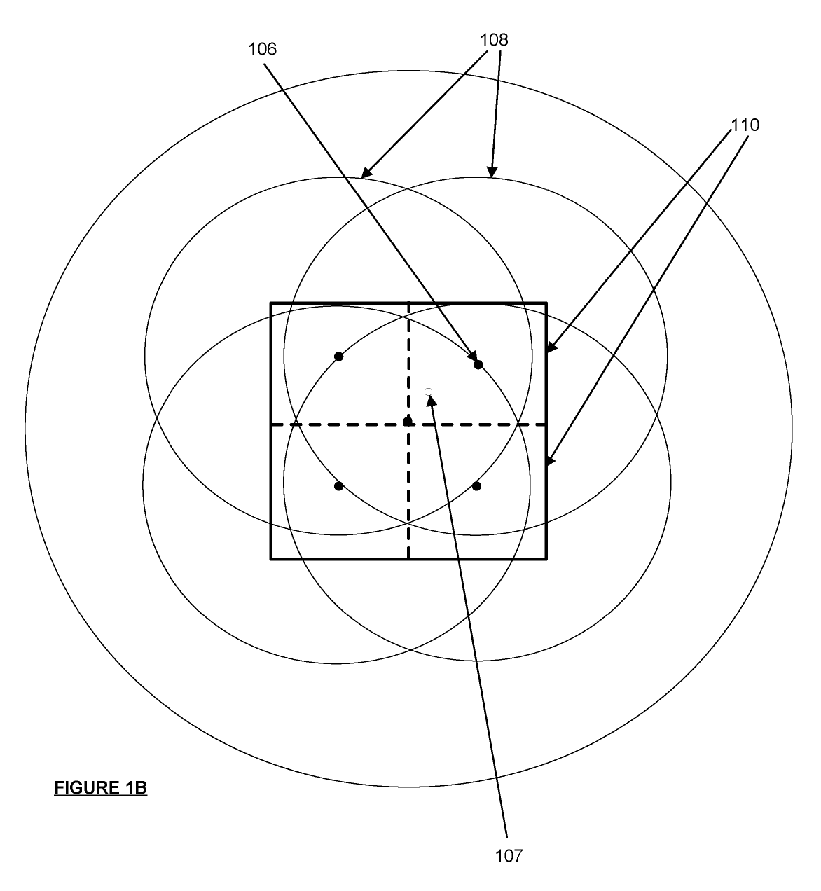

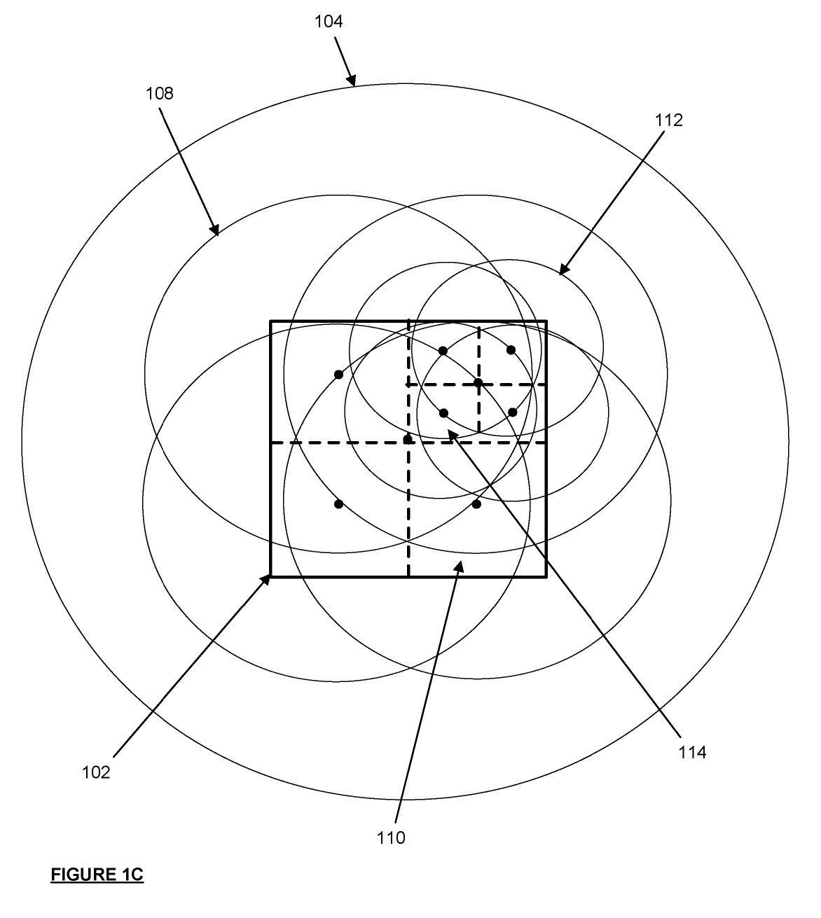

FIG. 1A is a graphical representation of a Level 0 root node of a two-dimensional P-tree data structure used to store data points of interest within a geographic region, in accordance with one embodiment. As depicted herein, a set of elements (i.e., dataset) is bounded by a rectangular region 102 on a Euclidean plane. The outlines of the rectangular region 102 may define a specific geographic region such as a country, state, city region, etc. In one embodiment, each element represents a unique geographic location of a defined static entity within a specific geographic region. For example, the geographical location may be that of a commercial business entity (e.g., restaurant, movie theatre, shopping mall, business, etc.), a public entity (e.g., government building, public park, etc), or other defined location. The geographic locations may be represented using longitude and latitude coordinates or similar coordinate system. In another embodiment, each element represents the geographic location of a dynamic entity within a specific geographic region. For example, each element may represent the dynamically tracked (i.e., through GPS or similar conventional method) location of an object such as a vehicle, an object, etc. In still another embodiment, each element represents the geographic location of an individual (i.e., person) within a specific geographic region. For example, each element may represent the dynamically tracked location (i.e., through GPS or similar conventional method) of an acquaintance, family member, co-worker, an individual fitting specific search criteria, etc.

Since, geographic searches are concerned with 2-dimensional space only, the P-tree root node 104 is represented here as a circular region that encompasses around the entire region occupied by the rectangular region 102. The root node center point 106 is located at the center of the rectangular region 102. Every element defined within rectangular region 102 lies within a distance that is one half the radius of the root node 104 away from the root node center point 106. In one embodiment, the radius of the root node 104 approximately equals the length of the longest diagonal of the rectangular region 102.

FIG. 1B is a graphical representation of a Level 1 set of sub-nodes in a two-dimensional P-tree data structure used to store data points of interest within a geographic region, in accordance with one embodiment. The rectangular region 102 is depicted here as being divided into four non-overlapping sub-rectangular regions 110. A division occurs whenever the number of elements (i.e., data points) inserted into the rectangular region 102 exceeds a maximum number for the node. In one embodiment, the maximum number of elements a node can hold is set by a database administrator. In another embodiment, the maximum number of elements a node can hold is determined based on the memory storage configuration of the database server hosting the data structure.

As alluded to earlier, each of the sub-rectangular regions 110 represents a distinct subset of the elements that comprise the data set bounded by the rectangular region 102. That is, the elements inserted into each of the sub-rectangular regions 110 are not duplicatively inserted into the other sub-rectangular regions 110. Contrastingly, each of the P-tree sub-node circles 108 are partitioned in such a manner that they substantially overlap with one another. That is, elements may be duplicatively inserted into more than one P-tree sub-node circle 108 within the same P-tree data structure. This is graphically shown in FIG. 1B, where a unique element 107 is shown to be inserted only in the upper right sub-rectangular region, whereas the same unique element 107 is inserted into all four of the overlapping P-tree sub-node circles 108 of the P-tree data structure. This addresses the topological problems associated with searching data structures that are disjointed and non-overlapping (i.e., B-trees and R-trees) by adding redundancies to the P-tree data structure to guarantee that if two points are sufficiently close together there will be some lower level tree node that will contain both of them so that both will be discovered during a search routine.

As with the P-tree root node circle, each of the P-tree sub-nodes circles 108 are rendered such that they have center points 106 that are positioned over the center of the sub-rectangular region 110 they cover. When elements are inserted into a P-tree data structure, they are first inserted into the P-tree root node and then to lower level P-tree sub-nodes 108 when a maximum number of elements have been inserted into the P-tree root node. Elements that are inserted into an area of the P-tree data structure with overlapping sub-node circles 108 are inserted into each of the overlapping sub-node circles 108, thus creating the redundancy described above.

It should be understood, that although the P-tree data structures are depicted in FIGS. 1A, 1B and 1C as having sets of four sub-nodes at every tree level (i.e., Level 1, Level 2, etc.), the number of sub-nodes at each tree level is really dependent upon the dimensional context of the space that is being covered by the data structure. That is the number of sub-nodes at each level is exponential based on the mathematical expression 2ⁿ, where n represents the number of dimensions for the space. For example, when a 2-dimensional space is being covered by a P-tree data structure, the P-tree root node is sub-divided into 4 P-tree sub-node circles 108.

FIG. 1C is a graphical representation of a complete two-dimensional P-tree data structure used to store data points of interest within a geographic region, in accordance with one embodiment. As depicted in this representation, the P-tree data structure stores a set of data points (i.e. data set S) scattered within a bounded region in a Euclidean space or surface, which allows for the efficient execution of distance based queries. For the purposes of this description, the bounded region is entirely covered by a rectangular region 102 (i.e. R). A key assumption of this depiction of the P-tree data structure is that no two distinct points in data set S occupies the same geographic position.

The P-tree data structure is comprised of a sequential set of nodes, each of which are associated with distinct circular regions (C₀ or Level 0 root node, C₁ or Level 1 sub-nodes, and C₂ or Level 2 sub-nodes). When these circular regions are rendered on a P-tree data structure, they completely cover the rectangular region 102 area that covers data set S. The technique for constructing the circles associated with the set of nodes in the P-tree data structure storing data set S is illustrated in FIG. 1C. C₀ consists of a single circle termed the root node circle 104, which is centered at the center of the rectangular region 102 and has a radius that equals the length of the longest diagonal of the rectangular region R 102. C₁ consists of 4 sub-node circles 108 constructed as follows. The rectangular region 102 is divided into 4 equal sub-rectangular regions 110, and for each of the sub-rectangular region 110 a sub-node circle 108 is constructed that is centered at the center of the sub-rectangular region 110. The sub-node circles 108 have a radius that is equal to the length of the longest diagonal of the sub-rectangular region 110.

C₂ consists of 16 sub-node circles 112 constructed by dividing each of the 4 sub-rectangular regions 110 described in the definition of C₁ into 4 sub-rectangular regions 114 and associating a sub-node circle 112 with each of those sub-rectangular regions 114. The sub-node circle 112 being centered at the center of the sub-rectangular region 114 with a radius that equals the length of the longest diagonal of the sub-rectangular region 114. It should be appreciated that the levels (i.e., C₁ and C₂) depicted herein are shown by way of example only, in practice a P-tree data structure may include more or less sub-node levels depending on the particular characteristics of data set S. Generally speaking, the number of sub-node circles at each sub-node level is determined by the expression Cₙ=4ⁿ, where n is the sub-node level. Furthermore, the expression rₙ=rₒ/(2ⁿ) describes the relationship between the root node circle 104 and associated sub-node circles (i.e., Level 1 sub-node 108 and Level 2 sub-node 112) at every level by taking rₒ to be the radius of the root node circle Cₒ and rₙ to be the radius of a sub-node circle Cₙ.

Several generalizations can be made about the P-tree data structure depicted in FIG. 1C. Because a given sub-node can appear on multiple search paths, P-tree data structures are in fact a series of finite directed acyclic graphs (DAGs). As such, a sub-node must be tagged as each is searched during a directed query to avoid slowing down the response time of a data query. The immediate descendents of a node (i.e., the “children” of the node) are associated with circles of a level that is greater or equal to the level of the node (i.e. as you go “down the tree” the radii of the circles are non-decreasing). Every point in the rectangle associated with the parent lies within ½ the radius of at least one of the circles associated with the children. The center of the circle associated with each child lies within the circle associated with its parent.

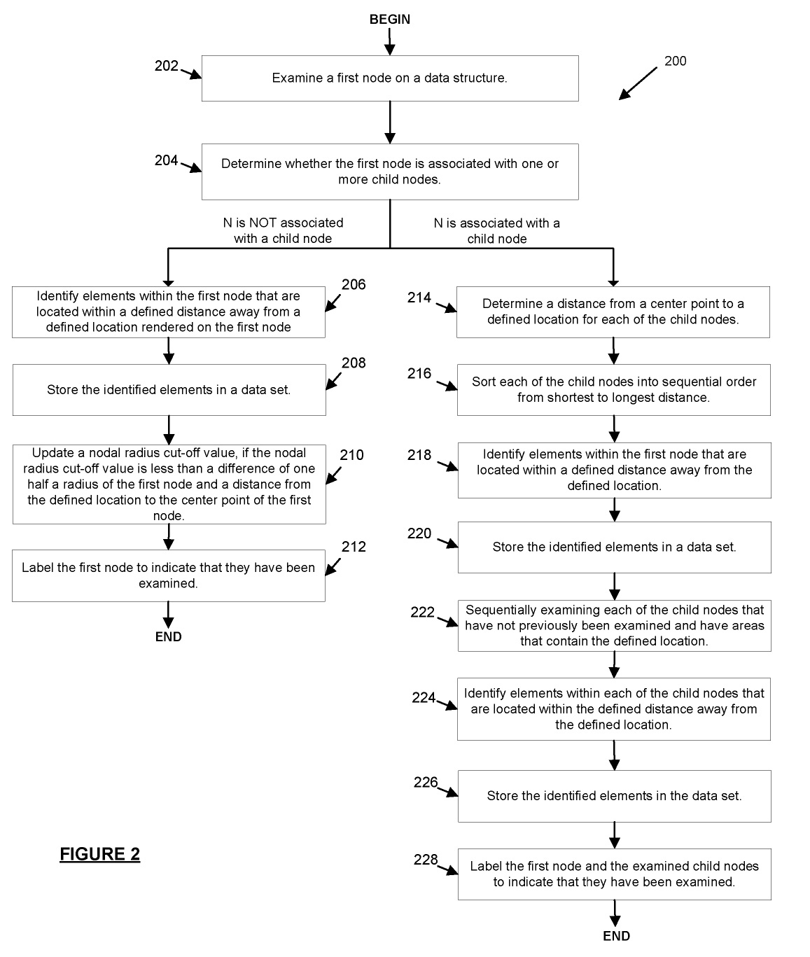

FIG. 2 is an illustration of a flowchart detailing a method for searching a two-dimensional P-tree data structure, in accordance with one embodiment. Method 200 may be implemented on any conventional computing device that can access the data stored in the P-tree data structure. Method 200 begins with operation 202 where the first node of the P-tree data structure is examined.

Method 200 proceeds on to operation 204 where a determination is made as to whether the first node is associated with one or more child nodes. That is a determination made as to whether the first node is a leaf node with no children nodes or a parent node that has one or more nodes associated with it.

When the first node is determined to not be associated with one or more child nodes, the method 200 proceeds to operation 206 where elements within the first node that are located within a defined distance away from a defined location rendered on the first node are identified. For example, if a search query is initiated with search parameters that seek all Italian restaurants (i.e., elements) located with a five-mile radius (i.e., defined distance) away from a user location (i.e., defined location), operation 206 will identify all the Italian restaurants stored in the P-tree data structure that satisfy the search parameters. In one embodiment, each element represents a unique geographic location of a defined static entity within a specific geographic region. For example, the geographical location may be that of a commercial business entity (e.g., restaurant, movie theatre, shopping mall, business, etc.), a public entity (e.g., government building, public park, etc), or other defined location. The geographic locations may be represented using longitude and latitude coordinates or similar coordinate system. In another embodiment, each element represents the geographic location of a dynamic entity within a specific geographic region. For example, each element may represent the dynamically tracked (i.e., through GPS or similar conventional method) location of an object such as a vehicle, an object, etc. In still another embodiment, each element represents the geographic location of an individual (i.e., person) within a specific geographic region. For example, each element may represent the dynamically tracked location (i.e., through GPS or similar conventional method) of an acquaintance, family member, co-worker, an individual fitting specific search criteria, etc.

Method 200 moves on to operation 208 where all the elements that are identified as satisfying the search parameters are stored to a data set. The data set may be organized as a text-based summary, a graphical representation of the data, or some other format that can adequately relay the data results to the originator of the query. In one embodiment, the data set is automatically returned to the originator of the query. In another embodiment, the data set is stored into the memory of the database server until retrieved by the originator of the query.

Method 200 continues on to operation 210 where a nodal radius cut-off value is updated if the nodal radius cut-off value is less than a difference of one half a radius of the first node and a distance from the defined location to the center point of the first node. The nodal radius cut-off value is updated after completing the search of any node to reflect that all the elements have been found within the updated nodal radius cut-off value of the given location.

Method 200 progresses to operation 212 where the first node is labeled (i.e., tagged) to indicate that the node has been examined. This tagging procedure is to prevent the node from being searched again as any given sub-node of a P-tree data structure can appear on multiple search paths.

When the first node is determined to be associated with one or more child nodes, the method 200 proceeds directly from operation 204 to operation 214 where the distance from a defined location to the center point of each of the child nodes is determined for each of the child nodes. For example, a defined location (i.e., user location) is rendered as a given point on the child node then the distance from the child node center point to that given point is determined.

Method 200 moves on to operation 216 where each of the child nodes associated with the first node is sorted in sequential order from the shortest distance to the longest distance. For example, child nodes 1 through 4 would be sorted sequentially based on the distance values (i.e., the distance from the center point of each child node to a defined location) determined for each of the child nodes. So where child node 1 has a distance value of 5, child node 2 has a distance value of 10, child node 3 has a distance value of 2 and child node 4 has a distance value of 1; the child nodes would be sequentially sorted as child nodes 4, 3, 1 and 2, respectively.

Method 200 continues on to operation 218 where elements within the first node that are located within a defined distance away from a defined location rendered on the first node are identified. This identification would be based on the search parameters of the query. In one embodiment, each element represents a unique geographic location of a defined static entity within a specific geographic region. For example, the geographical location may be that of a commercial business entity (e.g., restaurant, movie theatre, shopping mall, business, etc.), a public entity (e.g., government building, public park, etc), or other defined location. The geographic locations may be represented using longitude and latitude coordinates or similar coordinate system. In another embodiment, each element represents the geographic location of a dynamic entity within a specific geographic region. For example, each element may represent the dynamically tracked (i.e., through GPS or similar conventional method) location of an object such as a vehicle, an object, etc. In still another embodiment, each element represents the geographic location of an individual (i.e., person) within a specific geographic region. For example, each element may represent the dynamically tracked location (i.e., through GPS or similar conventional method) of an acquaintance, family member, co-worker, an individual fitting specific search criteria, etc.

Method 200 progresses to operation 220 where all the elements that are identified as satisfying the search parameters are stored to a data set. The data set may be organized as a text-based summary, a graphical representation of the data, or some other format that can adequately relay the data results to the originator of the query. In one embodiment, the data set is automatically returned to the originator of the query. In another embodiment, the data set is stored into the memory of the database server until retrieved by the originator of the query.

Method 200 proceeds on to operation 222 where each of the child nodes that have not previously been examined and contains the defined location are sequentially examined. In other words, each of the child nodes will be sequentially examined in an order that was previously determined in operation 216, unless the child node has previously been examined or does not contain a point that includes the defined location.

Method 200 continues on to operation 224 where elements that are located within a defined distance away from the defined location are identified for each of the child nodes. These elements would be the data points on each child node that satisfy the search parameters in the query. As described previously, in one embodiment, each element represents a unique geographic location of a defined static entity within a specific geographic region. For example, the geographical location may be that of a commercial business entity (e.g., restaurant, movie theatre, shopping mall, business, etc.), a public entity (e.g., government building, public park, etc), or other defined location. The geographic locations may be represented using longitude and latitude coordinates or similar coordinate system. In another embodiment, each element represents the geographic location of a dynamic entity within a specific geographic region. For example, each element may represent the dynamically tracked (i.e., through GPS or similar conventional method) location of an object such as a vehicle, an object, etc. In still another embodiment, each element represents the geographic location of an individual (i.e., person) within a specific geographic region. For example, each element may represent the dynamically tracked location (i.e., through GPS or similar conventional method) of an acquaintance, family member, co-worker, an individual fitting specific search criteria, etc.

Method 200 progresses to operation 226 where all the elements that are identified in each of the child nodes as satisfying the search parameters are stored to a data set. As described above, the data set may be organized as a text-based summary, a graphical representation of the data, or some other format that can adequately relay the data results to the originator of the query. In one embodiment, the data set is automatically returned to the originator of the query. In another embodiment, the data set is stored into the memory of the database server until retrieved by the originator of the query. Method 200 moves on to operation 228 where the first node and each of the examined child nodes are labeled as examined.

Provided below in Table A is a sample code for executing the above described search method, in accordance with one embodiment of the present invention. unsigned long ptreeCursorCurrentData(ptreeCursor*ptc) {return ptc->current.id; } long ptreeCursorCurrentRadius(ptreeCursor*ptc) {return ptc->current.dist; } char*ptreeCursorCurrentKey(ptreeCursor*ptc) {return ptc->currentkey; }

It should be appreciated that the sample code provided above in Table A is used for illustration purposes only and should in no way be interpreted as the only way in which the source code for search method 200 can be written.

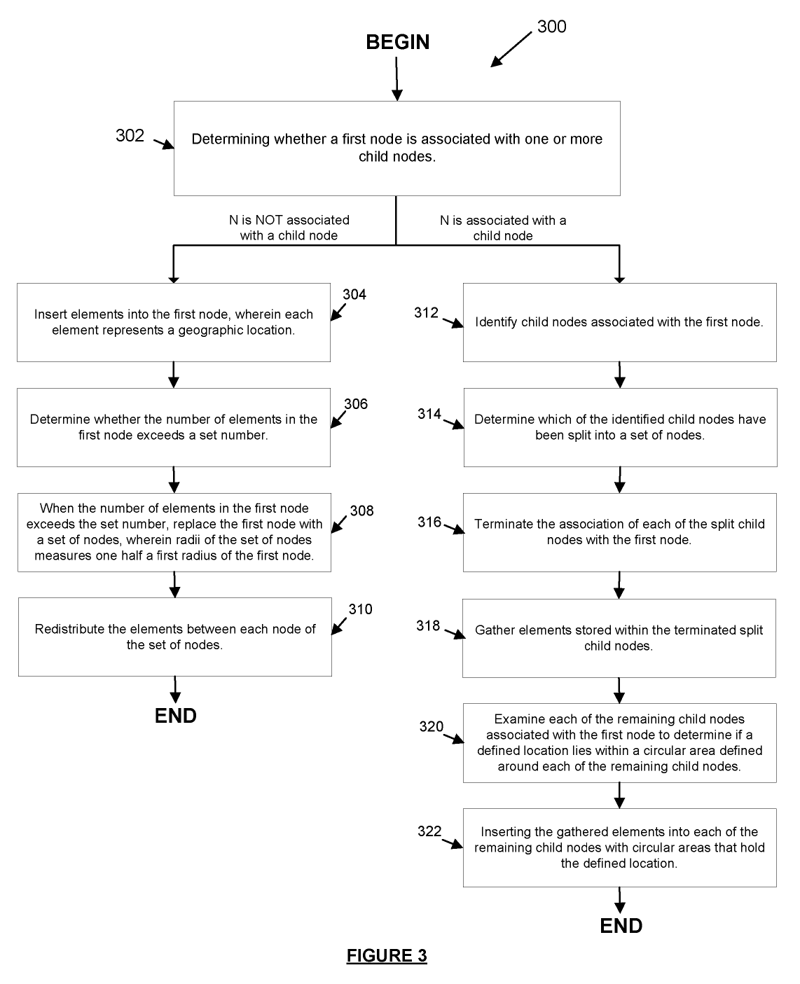

FIG. 3 is an illustration of a flowchart detailing a method for inserting database records in a two-dimensional P-tree data structure, in accordance with one embodiment. Method 300 begins with operation 302 where a determination is made as to whether a first node is associated with one or more child nodes. When the first node is determined not to be associated with a child node, the method 300 proceeds to operation 304 where elements are inserted into the first node, wherein each element represents a geographic location.

In one embodiment, each element represents a unique geographic location of a defined static entity within a specific geographic region. For example, the geographical location may be that of a commercial business entity (e.g., restaurant, movie theatre, shopping mall, business, etc.), a public entity (e.g., government building, public park, etc), or other defined location. The geographic locations may be represented using longitude and latitude coordinates or similar coordinate system. In another embodiment, each element represents the geographic location of a dynamic entity within a specific geographic region. For example, each element may represent the dynamically tracked (i.e., through GPS or similar conventional method) location of an object such as a vehicle, an object, etc. In still another embodiment, each element represents the geographic location of an individual (i.e., person) within a specific geographic region. For example, each element may represent the dynamically tracked location (i.e., through GPS or similar conventional method) of an acquaintance, family member, co-worker, an individual fitting specific search criteria, etc.

Method 300 continues on to operation 306 where a determination is made as to whether the number of elements in the first node exceeds a set number. In one embodiment, the set number of elements a node can hold is set by a database administrator. In another embodiment, the set number of elements a node can hold is determined based on the memory storage configuration of the database server hosting the P-tree data structure. When it is determined that the number of elements in the first node exceeds the set number, method 300 proceeds on to operation 308 where the first node is replaced with a set of nodes, wherein the radii of the set of nodes measures one half a first radius of the first node. For example, if the radius of the first node is 6, the radius of each of the nodes comprising the set of nodes will be 3.

Method 300 progresses to operation 310 where the elements are redistributed between each of the set of nodes. In one embodiment, the elements are redistributed only amongst the set of nodes in accordance with whether the elements fall within a region covered by a node within the set of nodes. That is, each element is inserted only into nodes that cover a region occupied by the element.

When the first node is determined to be associated with one or more child nodes, the method 300 proceeds to operation 312 where each of the child nodes associated with the first node is identified. Next, method 300 moves on to operation 314 where a determination is made as to which of the child nodes have been split into a set of nodes. For example, any child node that has one or more sub-nodes associated with it is identified as having been split.

Method 300 continues on to operation 316 where the association between the first node and any split child node is terminated. For example, if child node A is determined in operation 314 to have been split, the association between child node A and the first child node is extinguished.

Method 300 proceeds to operation 318 where all the elements within the terminated child nodes are gathered. In one embodiment, the elements that are gathered from the terminated child nodes are stored in a temporary memory register or cache of the computing device executing method 300. In another embodiment, the elements gathered from the terminated child nodes are stored in a temporary data set defined within the data structure.

Method 300 progresses on to operation 320 where each of the remaining child nodes that are associated with the first node are examined to determine if a defined location lies within a circular area defined around each of the remaining child nodes. In other words, each of the remaining non-terminated nodes are examined to determine if they cover an area where a defined location is located. In one embodiment, the defined location is the geographic location of the user executing the query.

Method 300 moves on to operation 322 where the gathered elements from operation 318 are inserted into each of the remaining child nodes with circular areas that hold the defined location.

Provided below in Table B is a sample code for executing the above described data insertion method, in accordance with one embodiment of the present invention.

```
TABLE B
/* Like files you use an integer to identify each ptree.
  You specify a ptree by
  * path in the file system to store the ptree nodes
  * the size of the keys (which are of fixed size),
  * a distance function: long keyDistance(void *key1,void *key2) that is
assumed to be metric
  * the number of elements in a node --
  ***WHICH MUST BE EVEN***
  * the blocksize used to store each node
  Tha API
  short openPtree
    (unsigned long ptreeID,char *path,unsigned long keysize,
    long (*keyDistance)(void*,void*),
    unsigned long nodelength,unsigned long blocksize,long cachelevel);
  void ptreeInsert(unsigned long ptreeID,void *key,unsigned long data);
  void ptreeDelete(unsigned long ptreeID,void *key,unsigned long data);
  /* This doesn't do node merging. */
  short closeAllPtrees( );
  short closePtree(unsigned long ptreeID);
  void syncPtree(unsigned long ptreeID);
  void syncAllPtrees( ); /* This should be called on startup to complete
  any pending commits and after each
                call to the te's commit. This corresponds
                to commitfilesm_transaction*/
  void ptreeRollback( );/* called after a te rollback */
  ptreeCursor *ptreeCursorSearch(unsigned long ptreeID, void *key,long
  radius);
  ptreeCursor *ptreeCursorSearch(ptree *pt, void *key,long rad);
  short ptreeCursorIsEmpty(ptreeCursor *ptc);
  unsigned long ptreeCursorGetNext(ptreeCursor *ptc,long *currradius);
  unsigned long ptreeCursorCurrentData(ptreeCursor *ptc);
  long ptreeCursorCurrentRadius(ptreeCursor *ptc);
  char *ptreeCursorCurrentKey(ptreeCursor *ptc);
  int ptreeCursorClose(ptreeCursor *ptc);
  Here's a sample program:
  #include <stdio.h>
  #include <string.h>
  #include “ptreeapi.h”
  #include “sldbreg.h”
  #include “tnodetestDB_ext.h”
  static int mystrcmp(void *s1,void *s2) {
    return (int)strcmp((char *)s1,(char *)s2);
  }
  static void insert(char *s,unsigned long m) {
    char key[20];
    strcpy((char *)&key,s);
    ptreeInsert(1,&key,m);
  }
  static void rinsert(unsigned long m) {
    char key[20];
    int i;
    for (i = 0;i<19;i++) {
    key[i] = (char)(random( ) % 128);
    }
    key[19] = 0;
    ptreeInsert(1,&key,m);
  }
  int main(int argc,char **argv) {
  char *SMRegisterArgs[ ] = {“db.edb”, “VALIDATE=t”};
  char *SMRegisterArgsMod[ ] = {“mod.edb”, “VALIDATE=t”};
  char *IndexRegisterArgs[ ] = {“maj=53, min=13”, “ ”};
  long i;
  long j;
  long p;
  char *testkeys[10];
  unsigned long testdata[10];
  edb_RegisterService(“SM”,
                (edb_serviceRegFuncPtr) SM_Default_Register,
                2, (void**)SMRegisterArgs);
  edb_RegisterService(“SM:MOD”,
                  (edb_serviceRegFuncPtr) SM_Default_Register,
                  2, (void**)SMRegisterArgsMod);
  edb_RegisterService(“INDEX:Hash”,
                  (edb_serviceRegFuncPtr) INDEX_Hash_Register,
                  2, (void**)IndexRegisterArgs);
  ptreeCursor *btc;
    edb_Open( );
    openPtree(1,“foobar”,20,mystrcmp,128,4096,2);
    syncPtree(1);
  #ifdef INSERTSTUFF
    for (j = 0;j<10;j++) {
    p = j*100000;
    for (i = 0; i < 100000;i++) {
      rinsert((unsigned long) p+i);
    }
    ptreeCommit( ); /* the name I used for my exported te commit */
    syncPtree(1);
    ptreeCommit( );
    printf(“Count: %d\n”,p);
    }
  #endif
    btc = ptreeCursorSearch(1,“ ”,“ ”,ALL,0);
    j = 0;
    i = 0;
    while (!ptreeCursorIsEmpty(btc)) {
    if ((j % 100000) == 0) {
      testkeys[i] = strdup((char *)ptreeCursorCurrentKey(btc));
      testdata[i] = ptreeCursorCurrentData(btc);
      i++;
    }
    ptreeCursorGetNext(btc);
    j++;
    }
    ptreeCursorClose(btc);
    printf(“Count: %d\n”,j);
    for(i = 0;i<10;i++) {
    printf(“Key: %s, Data: %d\n”,testkeys[i],testdata[i]);
    }
    for(i = 0;i<10;i++) {
    btc = ptreeCursorSearch(1,testkeys[i],“ ”,EQ,0);
    printf(“Key: %s,
    Data: %d\n”,testkeys[i],ptreeCursorCurrentData(btc));
    ptreeCursorClose(btc);
    }
    closePtree(1);
    ptreeCommit( );
    edb_Close( );
  }
```

It should be appreciated that the sample code provided above in Table B is used for illustration purposes only and should in no way be interpreted as the only way in which the source code for data insertion method 300 can be written.

The embodiments, described herein, can be practiced with other computer system configurations including hand-held devices, microprocessor systems, microprocessor-based or programmable consumer electronics, minicomputers, mainframe computers and the like. The embodiments can also be practiced in distributing computing environments where tasks are performed by remote processing devices that are linked through a network.

It should also be understood that the embodiments described herein can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations that form part of the embodiments described herein are useful machine operations. The invention also relates to a device or an apparatus for performing these operations. The systems and methods described herein can be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The embodiments described herein can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Certain embodiments can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Although a few embodiments of the present invention have been described in detail herein, it should be understood, by those of ordinary skill, that the present invention may be embodied in many other specific forms without departing from the spirit or scope of the invention. Therefore, the present examples and embodiments are to be considered as illustrative and not restrictive, and the invention is not to be limited to the details provided therein, but may be modified and practiced within the scope of the appended claims.

What is claimed is:

1. A computer implemented method for searching a data structure, comprising:
examining a first node on the data structure;
determining whether the first node is associated with one or more child nodes;
when the first node is not associated with one or more child nodes, identifying elements within the first node that are located within a defined distance away from a defined location rendered on the first node;
storing the identified elements in a data set;
updating a nodal radius cut-off value if the nodal radius cut-off value is less than a difference of one half a radius of the first node and a distance from the defined location to the center point of the first node; and
labeling the first node to indicate that the node has been examined.

2. The computer implemented method for searching a data structure, as recited in claim 1, further including,
when the first node is associated with one or more child nodes, determining a distance from a center point to a defined location for each of the child nodes;
sorting each of the child nodes into sequential order from shortest to longest distance;
identifying elements within the first node that are located within a defined distance away from the defined location;
storing the identified elements in a data set;
sequentially examining each of the child nodes that have not previously been examined and have areas that contain the defined location;
identify elements within each of the child nodes that are located within the defined distance away from the defined location;
storing the identified elements in the data set; and
labeling the first node and the examined child nodes to indicate that they have been examined.

3. The computer implemented method for searching a data structure, as recited in claim 1, wherein, the data structure is a proximity tree.

4. The computer implemented method for searching a data structure, as recited in claim 3, wherein the proximity tree is a finite directed acyclic graph (DAG).

5. The computer implemented method for searching a data structure, as recited in claim 1, wherein each of the child nodes associated with the first node has a center point that lies within a distance that is one half of the radius of the first node away from a center point of the first node.

6. The computer implemented method for searching a data structure, as recited in claim 1, wherein each element corresponds to a geographic location.

7. The computer implemented method for searching a data structure, as recited in claim 6, wherein the geographic location is a commercial entity.

8. The computer implemented method for searching a data structure, as recited in claim 1, wherein the search is conducted relative to the defined location.

9. A computer implemented method for inserting database records into a data structure, comprising:
determining whether a first node in the data structure is associated with one or more child nodes;
when the first node is not associated with one or more child nodes, inserting elements into the first node, wherein each element represents a geographic location; and
determining whether the number of elements in the first node exceeds a set number, wherein, if the number of elements in the first node does exceed the set number, replacing the first node with a set of nodes, wherein radii of the set of nodes measures one half a first radius of the first node, and redistributing the elements between each node of the set of nodes.

10. The computer implemented method for inserting database records into a data structure, as recited in claim 3, further including:
when the first node is associated with one or more child nodes, identifying child nodes associated with the first node;
determining which of the identified child nodes have been split;
terminating the association of each of the split child nodes with the first node gathering elements stored within the terminated split child nodes;
examining each of the remaining child nodes associated with the first node to determine if a defined location lies within a circular area defined around each of the remaining child nodes; and
inserting the gathered elements into each of the remaining child nodes with circular areas that hold the defined location.

11. The computer implemented method for inserting database records into a data structure, as recited in claim 9, wherein, the data structure is a proximity tree.

12. The computer implemented method for inserting database records into a data structure, as recited in claim 11, wherein the proximity tree is a finite directed acyclic graph (DAG).

13. The computer implemented method for inserting database records into a data structure, as recited in claim 10, wherein each of the child nodes associated with the first node has a center point that lies within a distance that is one half of the first radius of the first node away from a center point of the first node.

14. The computer implemented method for inserting database records into a data structure, as recited in claim 9, wherein each element corresponds to a geographic location.

15. The computer implemented method for inserting database records into a data structure, as recited in claim 14, wherein the geographic location is a commercial entity.

16. The computer implemented method for inserting database records into a data structure, as recited in claim 10, wherein identical elements may be indexed into more than one child node.

17. A data tree structure for storing a dataset to be indexed and searched based on distance criteria, comprising:
a root node defined by a root node center point and a root node radius, the root node configured to store elements that comprise the dataset; and
a first sub-node associated with the root node, the first sub-node defined by a first sub-node center point and a first sub-node radius, wherein the first sub-node center point lies within one half the root node radius away from the root node center point and is configured to store a portion of the elements that comprise the dataset.

18. The data tree structure for storing a dataset to be indexed and searched based on distance criteria, as recited in claim 17, wherein each element corresponds to a unique geographical location.

19. The data tree structure for storing a dataset to be indexed and searched based on distance criteria, as recited in claim 18, wherein the unique geographic location is a commercial entity.

20. The data tree structure for storing a dataset to be indexed and searched based on distance criteria, as recited in claim 17, wherein every path from the root node to the first sub-node has the same length.

21. The data tree structure for storing a dataset to be indexed and searched based on distance criteria, as recited in claim 17, wherein the first sub-node is configured to be associated with one or more child nodes.

22. The data tree structure for storing a dataset to be indexed and searched based on distance criteria, as recited in claim 17, wherein, the data structure is a proximity tree.

23. The data tree structure for storing a dataset to be indexed and searched based on distance criteria, as recited in claim 22, wherein the proximity tree is a finite directed acyclic graph (DAG).
